(19) United States
(12) Patent Application Publication
(10) Pub. No.: US 2008/0266122 A1
(43) Pub. Date: Oct. 30, 2008

(54) Wetness sensor with audible signal for an absorbent article

(75) Inventors: Thomas Michael Ales, Neenah, WI (US); Andrew Mark Long, Appleton, WI (US); Michael A. Bergemann, Mequon, WI (US)

Correspondence Address: DORITY & MANNING, P.A., POST OFFICE BOX 1449, GREENVILLE, SC, 29602-1449, US

(73) Assignee: Kimberly-Clark Worldwide, Inc.

(21) Appl. No.: 11/799,029

(22) Filed: Apr. 30, 2007

(51) Int. Cl. G08B 21/00

(52) U.S. Cl. 340/604

(57) ABSTRACT

A signaling device for absorbent articles is disclosed. A signaling device is configured to be electrically connected to a wetness sensor contained in the absorbent article. When a conductive substance is detected in the absorbent article, the wetness sensor is activated causing the signaling device to emit an audible signal. In accordance with the present disclosure, the signaling device is adjusted and configured such that the audible signal emits and adjusted so that the audible signal has a frequency or range of frequencies that maximizes perceived loudness in a particular environment.

### BACKGROUND

Absorbent articles such as diapers, training pants, incontinence products, feminine hygiene products, swim undergarments, and the like conventionally include a liquid permeable body-side liner, a liquid impermeable outer cover, and an absorbent core. The absorbent core is typically located in between the outer cover and the liner for taking in and retaining liquids (e.g., urine) exuded by the wearer.

The absorbent core can be made of, for instance, superabsorbent particles. Many absorbent articles, especially those sold under the tradename HUGGIES™ by the Kimberly-Clark Corporation, are so efficient at absorbing liquids that it is sometimes difficult to tell whether or not the absorbent article has been insulted with a body fluid.

Accordingly, various types of moisture or wetness indicators have been suggested for use in absorbent articles. The wetness indicators may include alarm devices that are designed to assist parents or attendants identify a wet diaper condition early on. The devices can produce an audible signal.

The alarm device ideally produces an audible signal that is loud enough to alert the caregiver without producing a sound that disturbs others or is otherwise annoying. Problems, however, have been encountered in designing an alarm device that produces an audible signal that can consistently be heard in different environments. Further, the alarm devices are typically worn under clothing that may have a tendency to absorb much of the sound. The loudness of the audible signal can also decrease based upon whether the wearer of the absorbent garment is sitting, standing or lying down.

In the past, those skilled in the art have proposed increasing the loudness of the audio signal by increasing the audio power or intensity of the signal. Increasing the audio power or intensity of the signal, however, cannot only produce an audible signal that is annoying to others but also can significantly shorten the life of the battery contained in the alarm device. As such, a need currently exists for a signaling device that can produce an audible signal with sufficient loudness while also conserving battery power.

### SUMMARY

The present disclosure is generally directed to a signaling device that is particularly well suited for use in conjunction with absorbent articles. The signaling device, for instance, may be connected to a wetness sensor in the absorbent article and can be configured to emit an audible signal for indicating to a user that a body fluid is present in the absorbent article. For example, in one embodiment, the absorbent article comprises a diaper and the wetness sensing device in conjunction with the signaling device is configured to indicate the presence of urine or a bowel movement. In other absorbent articles, however, the wetness sensing device and the signaling device may be configured to indicate the presence of yeast or metabolites.

More particularly, the present disclosure is directed to a signaling device as described above that emits an audible signal with sufficient loudness to be heard by a user and/or caregiver while at the same time conserving battery power. In accordance with the present disclosure, the frequency or frequency range of the audible signal is adjusted depending upon the environment so that the perceived loudness of the audible signal is enhanced without having to significantly increase audio power.

For instance, in one embodiment, the present disclosure is directed to an absorbent article comprising a chassis that includes an outer cover having an interior surface and an exterior surface. An absorbent structure is positioned adjacent to the interior surface of the outer cover. The chassis may include, for instance, a crotch region positioned in between a front region and a back region. The front region and the back region may define a waist region therebetween.

In accordance with the present disclosure, the absorbent article includes a wetness sensing device that is activated when a conductive substance is detected in the absorbent article. For instance, the wetness sensing device can include first and second conductive elements contained in the chassis. The conductive elements may extend from the waist region to the crotch region without intersecting. The first and second conductive elements can form part of a circuit that is configured to sense the presence of a conductive substance.

The wetness sensing device further includes a signaling device that produces an audible signal when the wetness sensing device is activated. The signaling device is configured to emit an audible signal that has an intensity of less than about 80 dB. The audible signal can further include a frequency or range of frequencies that are selected such that the intensity of the audible signal is at least about 48 dB at a distance of 20 feet from the signaling device.

In many applications, the signaling device is directly attached to the absorbent article. Thus, in many environments, the clothing of the wearer of the absorbent article may cover the signaling device. In these applications, the frequency or range of frequencies can also be selected such that the intensity of the audible signal decreases by no more than about 15 percent, such as no more than about 10 percent, when covered by a cotton cloth as defined below.

By adjusting the frequency of the audible signal as described above, a signal is produced with sufficient perceived loudness while conserving battery life. The battery present in the signaling device, for instance, can have at least 72 hours of useful life even if the signaling device were to continuously emit the audible signal. As described above, the audible signal can have an initial intensity of less than about 80 dB, such as even less than about 70 dB while still being loud enough to alert caregivers and wearers of the absorbent article and without producing a sound that is unreasonably annoying to others.

The actual frequency of the audible signal can vary depending upon the particular application and the environment in which the absorbent article is worn. The frequency, for instance, can range from about 500 Hz to about 2000 Hz, such as from about 500 Hz to about 1000 Hz. The audible signal can be, for instance, a solid tone, a repeating tone, or a sequence of variable tones. In one embodiment, for instance, the audible signal can comprise a voice or music recording.

Any suitable signaling device can be used in the present disclosure as long as the signaling device is capable of emitting an audible signal at the desired frequency. In one embodiment, for instance, the signaling device may comprise a piezoelectric device. A signaling device can include, for instance, a sound producing apparatus contained in an acoustic chamber. In one embodiment, in order to optimize loudness, the frequency of the acoustic chamber can substantially match the resonance frequency of the audible signal.

The absorbent article used with the signaling device can vary. The absorbent articles that may be made in accordance with the present disclosure include, for instance, diapers, training pants, swim pants, adult incontinence products, feminine hygiene products, and the like.

Other features and aspects of the present invention are discussed in greater detail below.

### BRIEF DESCRIPTION OF THE DRAWINGS

A full and enabling disclosure of the present invention, including the best mode thereof to one skilled in the art, is set forth more particularly in the remainder of the specification, including reference to the accompanying figures, in which:

FIG. 1 is a rear perspective view of one embodiment of an absorbent article made in accordance with the present invention;

FIG. 2 is a front perspective view of the absorbent article illustrated in FIG. 1;

FIG. 3 is a plan view of the absorbent article shown in FIG. 1 with the article in an unfastened, unfolded and laid flat condition showing the surface of the article that faces away from the wearer;

FIG. 4 is a plan view similar to FIG. 3 showing the surface of the absorbent article that faces the wearer when worn and with portions cut away to show underlying features;

FIG. 5 is a perspective view of the embodiment shown in FIG. 1 further including one embodiment of a signaling device;

FIG. 6 is a side view of a diaphragm that may be used to emit an audio signal for use in a signaling device according to the present disclosure;

FIG. 7 is a plan view of the diaphragm illustrated in FIG. 6; and

FIG. 8 is a cross-sectional view of one embodiment of a signaling device that may be used in accordance with the present disclosure.

Repeat use of reference characters in the present specification and drawings is intended to represent the same or analogous features or elements of the present invention.

### DETAILED DESCRIPTION OF THE INVENTION

It is to be understood by one of ordinary skill in the art that the present discussion is a description of exemplary embodiments only, and is not intended as limiting the broader aspects of the present disclosure.

The present disclosure is generally directed to signaling devices for absorbent articles. The signaling devices are configured to communicate with a wetness sensing device contained within the absorbent article. When a conductive substance is detected within the absorbent article, the wetness sensing device is activated causing the signaling device to emit an audible signal. The absorbent article may be, for instance, a diaper, a training pant, an incontinence product, a feminine hygiene product, a medical garment, a bandage, and the like. Absorbent articles made according to the present disclosure may include, for instance, an open circuit that becomes closed when a conductive fluid, such as a body fluid, is sensed in between a pair of conductive leads. Generally, the absorbent articles containing the open circuit are disposable meaning that they are designed to be discarded after a limited use rather than being laundered or otherwise restored for reuse.

The open circuit contained within the absorbent articles of the present disclosure is configured to be attached to the signaling device. The signaling device can provide power to the open circuit while also including some type of audible signal that indicates to the user the presence of a body fluid. Although the absorbent article itself is disposable, the signaling device may be reusable from article to article.

In accordance with the present disclosure, the signaling device is configured to emit an audible signal with sufficient perceived loudness so that it can be heard by a caregiver without increasing the intensity of the signal to a point where battery power is sacrificed. More particularly, the signaling device of the present disclosure can be configured to emit an ideal alarm volume that is loud enough to alert caregivers and/or the person wearing the absorbent garment and yet not be significantly annoying to others. The objectives of the present disclosure can be obtained, in one embodiment, by adjusting the frequency of the audible signal being emitted by the signaling device at a particular intensity level depending upon the environment in which the signaling device is to be used. For example, the signaling device can be adjusted so as to have sufficient perceived loudness even when covered by the user's clothes.

If a sound originates from a point source, such as a signaling device, the sound waves that are produced are spherical and spread into all directions. Sound waves have an intensity that is typically measured in decibels (dB). A decibel is actually a ratio used in acoustics to quantify sound levels. More specifically, decibels quantify sound intensity in terms of logarithmic units.

As sound travels from a point source, the sound waves decrease in intensity. The decrease in intensity is due to attenuation and absorption. Attenuation is the diminution in intensity for any cause whatsoever. Attenuation is generally proportional to the square of sound frequency.

Absorption, on the other hand, is when an object or material in the environment absorbs the sound wave. The sound absorption properties of a material are quantified by its sound absorption coefficient. The sound absorption coefficient of a material, for instance, can be from 0 to 1, with 0 representing no absorption and total reflection or transmittance in this case, through the article of clothing with no attenuation, and 1 representing total absorption of all the incident sound. The sound absorption coefficient of any particular material or object varies with the frequency of sound. The sound absorption is the absorption footprint of the specimen in metric sabins. The sound absorption coefficient is the percentage of incident sound energy that, rather than being reflected is converted to other forms of energy.

Thus, when designing a signaling device in accordance with the present disclosure, the signaling device can emit an audible signal that takes into account or otherwise factors in attenuation and absorption of the audible signal based upon the environment in which the signaling device is used.

The intensity of the audible signal, however, is not the only variable to consider when designing the signaling device. For example, perceived loudness is the quality of a sound that is the primarily psychological correlate of physical intensity. Loudness is a subjective measure that is not based solely on sound intensity. Perceived loudness of an audible signal is not only affected by intensity, but is also affected by frequency and duration. Signaling devices produced according to the present disclosure are intended to produce an audible signal that has a maximum perceived loudness without having to increase the power of the audio signal to a point that compromises battery power. In particular, frequency and other variables are adjusted in the signaling device so as to produce an audible signal with sufficient loudness without having to increase the intensity to a point where the battery that powers the signaling device becomes exhausted in less than a certain period of time, such as less than about 72 hours should the audible signal be emitted from the signaling device in a continuous state.

For example, in one embodiment, the signaling device can be configured to emit an audible signal having an initial intensity of less than about 80 dB, such as less than about 70 dB. The audible signal can have a frequency or a range of frequencies that are selected such that the intensity of the audible signal is at least about 48 dB at a distance of 20 feet from the signaling device. In certain embodiments, the present inventors have discovered that a sound intensity of 48 dB at a selected frequency can have sufficient perceived loudness to alert a caregiver that the signaling device has been activated.

In accordance with the present disclosure, intensity measurements are made according to ASTM standards. In particular, sound intensity measurements can be made according to ASTM Standard Test Method E1574-98 as re-approved on Apr. 1, 2006. As used herein, sound measurements are taken at the desired distance with an unobstructed view of the signaling device.

The frequency or range of frequencies of the audible signal can vary from about 500 Hz to about 2000 Hz, and in particular from about 500 Hz to about 1000 Hz. The audible signal can be a solid tone, can be a repetitive tone, or can be a sequence of variable tones. In one particular embodiment, for instance, the audible sound can comprise a voice or musical recording.

As described above, in many applications signaling devices attached to absorbent articles are typically worn under the garment of a user. Thus, in one embodiment, the audible signal can be at a frequency or a frequency range that is selected such that the intensity decreases by no more than about 15 percent, such as no more than about 10 percent, when covered by a standard cotton cloth.

As used herein, a “standard cotton cloth” generally refers to a cotton cloth that is typically used to form clothing, such as shirts, including tee shirts. More specifically, a “standard cotton cloth” refers to a 100% cotton interlock knitted (Jersey knit) fabric that has a weight of 6.1 OSY (207 gsm) and is made from ring spun cotton spun yarns. When conducting tests in accordance with the present disclosure, the cotton cloth can be placed over the signal device. The cotton cloth can be dyed but is uncoated with other layers.

Similarly, the audible signal can also be at a frequency or a frequency range that is selected such that the intensity decreases by no more than about 15%, such as no more than about 10% when covered by a standard polyester/cotton woven fabric. As used herein, a “standard polyester/cotton woven fabric” refers to a typical fabric used to produce dress shirts. The standard polyester/cotton woven fabric is made from a mixture of 65% polyester yarns and 35% cotton yarns. In particular, the polyester yarns run in the warp direction while the cotton yarns run in the fill direction. The polyester yarns are multifilament yarns while the cotton yarns are spun yarns that are ring spun. The standard polyester/cotton woven fabric has a weight of 4.25 osy.

In still another embodiment, the frequency or frequency range of the audible signal can be adjusted and/or selected such that the intensity decreases by no more than about 15%, such as no more than about 10%, when covered by a standard denim fabric. As used herein, a “standard denim fabric” refers to a denim fabric that is typically used to produce jeans. A standard denim fabric is made from 100% cotton spun yarns that are ring spun. The standard denim fabric has a warp faced twill weave. As used herein, a standard denim fabric has a weight of 10 osy.

The signaling device is typically connected to an open circuit that is configured to indicate the presence of a body fluid contained within an absorbent article. The particular targeted body fluid may vary depending upon the particular type of absorbent article and the desired application. For instance, in one embodiment, the absorbent article comprises a diaper, a training pant, or the like and the signaling device is configured to indicate the presence of urine. Alternatively, the signaling device may be configured to indicate the presence of a metabolite that would indicate the presence of a diaper rash. For adult incontinence products and feminine hygiene products, on the other hand, the signaling device may be configured to indicate the presence of a yeast or of a particular constituent in urine, such as a polysaccharide.

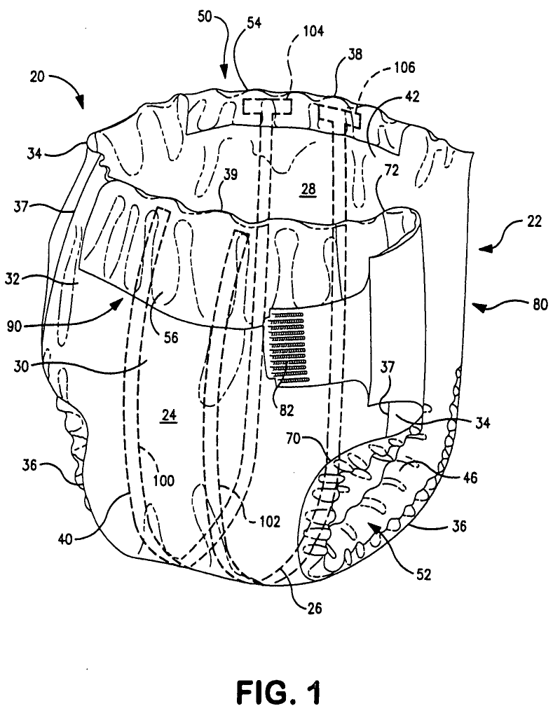

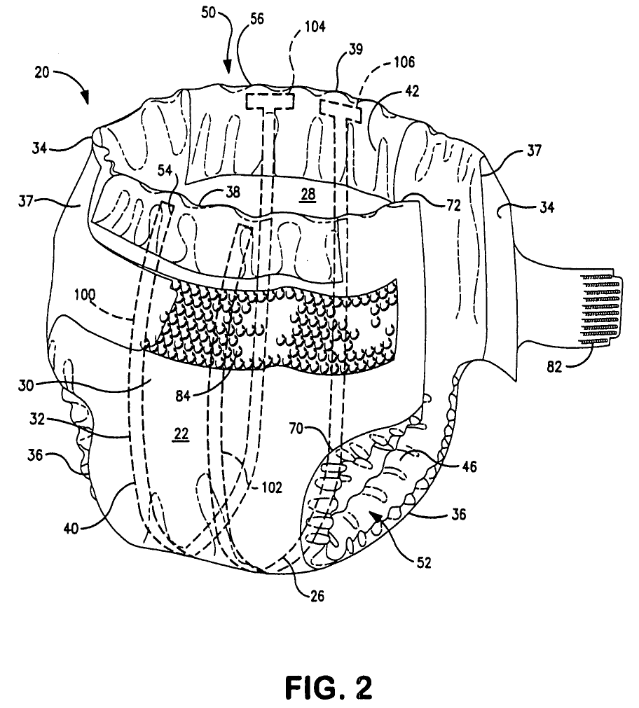

Referring to FIGS. 1 and 2, for exemplary purposes, an absorbent article 20 that may be made in accordance with the present invention is shown. The absorbent article 20 may or may not be disposable. It is understood that the present invention is suitable for use with various other absorbent articles intended for personal wear, including but not limited to diapers, training pants, swim pants, feminine hygiene products, incontinence products, medical garments, surgical pads and bandages, other personal care or health care garments, and the like without departing from the scope of the present invention.

By way of illustration only, various materials and methods for constructing absorbent articles such as the diaper 20 of the various aspects of the present invention are disclosed in PCT Patent Application WO 00/37009 published Jun. 29, 2000 by A. Fletcher et al; U.S. Pat. No. 4,940,464 issued Jul. 10, 1990 to Van Gompel et al.; U.S. Pat. No. 5,766,389 issued Jun. 16, 1998 to Brandon et al., and U.S. Pat. No. 6,645,190 issued Nov. 11, 2003 to Olson et al. which are incorporated herein by reference to the extent they are consistent (i.e., not in conflict) herewith.

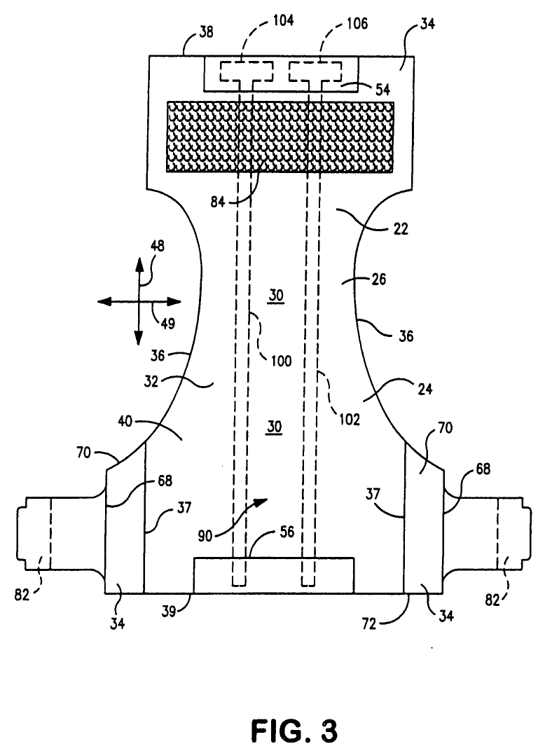

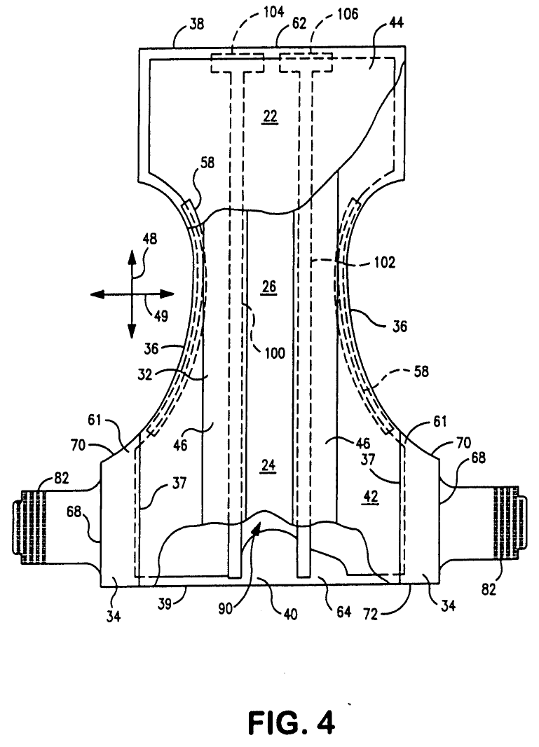

A diaper 20 is representatively illustrated in FIG. 1 in a partially fastened condition. The diaper 20 shown in FIGS. 1 and 2 is also represented in FIGS. 3 and 4 in an opened and unfolded state. Specifically, FIG. 3 is a plan view illustrating the exterior side of the diaper 20, while FIG. 4 illustrates the interior side of the diaper 20. As shown in FIGS. 3 and 4, the diaper 20 defines a longitudinal direction 48 that extends from the front of the article when worn to the back of the article. Opposite to the longitudinal direction 48 is a lateral direction 49.

The diaper 20 defines a pair of longitudinal end regions, otherwise referred to herein as a front region 22 and a back region 24, and a center region, otherwise referred to herein as a crotch region 26, extending longitudinally between and interconnecting the front and back regions 22, 24. The diaper 20 also defines an inner surface 28 adapted in use (e.g., positioned relative to the other components of the article 20) to be disposed toward the wearer, and an outer surface 30 opposite the inner surface. The front and back regions 22, 24 are those portions of the diaper 20, which when worn, wholly or partially cover or encircle the waist or mid-lower torso of the wearer. The crotch region 26 generally is that portion of the diaper 20 which, when worn, is positioned between the legs of the wearer and covers the lower torso and crotch of the wearer. The absorbent article 20 has a pair of laterally opposite side edges 36 and a pair of longitudinally opposite waist edges, respectively designated front waist edge 38 and back waist edge 39.

The illustrated diaper 20 includes a chassis 32 that, in this embodiment, encompasses the front region 22, the back region 24, and the crotch region 26. Referring to FIGS. 1-4, the chassis 32 includes an outer cover 40 and a bodyside liner 42 (FIGS. 1 and 4) that may be joined to the outer cover 40 in a superimposed relation therewith by adhesives, ultrasonic bonds, thermal bonds or other conventional techniques. Referring to FIG. 4, the liner 42 may suitably be joined to the outer cover 40 along the perimeter of the chassis 32 to form a front waist seam 62 and a back waist seam 64. As shown in FIG. 4, the liner 42 may suitably be joined to the outer cover 40 to form a pair of side seams 61 in the front region 22 and the back region 24. The liner 42 can be generally adapted, i.e., positioned relative to the other components of the article 20, to be disposed toward the wearer's skin during wear of the absorbent article. The chassis 32 may further include an absorbent structure 44 particularly shown in FIG. 4 disposed between the outer cover 40 and the bodyside liner 42 for absorbing liquid body exudates exuded by the wearer, and may further include a pair of containment flaps 46 secured to the bodyside liner 42 for inhibiting the lateral flow of body exudates.

The elasticized containment flaps 46 as shown in FIG. 4 define a partially unattached edge which assumes an upright configuration in at least the crotch region 26 of the diaper 20 to form a seal against the wearer's body. The containment flaps 46 can extend longitudinally along the entire length of the chassis 32 or may extend only partially along the length of the chassis. Suitable constructions and arrangements for the containment flaps 46 are generally well known to those skilled in the art and are described in U.S. Pat. No. 4,704,116 issued Nov. 3, 1987 to Enloe, which is incorporated herein by reference.

To further enhance containment and/or absorption of body exudates, the diaper 20 may also suitably include leg elastic members 58 (FIG. 4), as are known to those skilled in the art. The leg elastic members 58 can be operatively joined to the outer cover 40 and/or the bodyside liner 42 and positioned in the crotch region 26 of the absorbent article 20.

The leg elastic members 58 can be formed of any suitable elastic material. As is well known to those skilled in the art, suitable elastic materials include sheets, strands or ribbons of natural rubber, synthetic rubber, or thermoplastic elastomeric polymers. The elastic materials can be stretched and adhered to a substrate, adhered to a gathered substrate, or adhered to a substrate and then elasticized or shrunk, for example with the application of heat, such that elastic retractive forces are imparted to the substrate. In one particular aspect, for example, the leg elastic members 58 may include a plurality of dry-spun coalesced multifilament spandex elastomeric threads sold under the trade name LYCRA and available from Invista, Wilmington, Del., U.S.A.

In some embodiments, the absorbent article 20 may further include a surge management layer (not shown) which may be optionally located adjacent the absorbent structure 44 and attached to various components in the article 20 such as the absorbent structure 44 or the bodyside liner 42 by methods known in the art, such as by using an adhesive. A surge management layer helps to decelerate and diffuse surges or gushes of liquid that may be rapidly introduced into the absorbent structure of the article. Desirably, the surge management layer can rapidly accept and temporarily hold the liquid prior to releasing the liquid into the storage or retention portions of the absorbent structure. Examples of suitable surge management layers are described in U.S. Pat. No. 5,486,166; and U.S. Pat. No. 5,490,846. Other suitable surge management materials are described in U.S. Pat. No. 5,820,973. The entire disclosures of these patents are hereby incorporated by reference herein to the extent they are consistent (i.e., not in conflict) herewith.

As shown in FIGS. 1-4, the absorbent article 20 further includes a pair of opposing elastic side panels 34 that are attached to the back region of the chassis 32. As shown particularly in FIGS. 1 and 2, the side panels 34 may be stretched around the waist and/or hips of a wearer in order to secure the garment in place. As shown in FIGS. 3 and 4, the elastic side panels are attached to the chassis along a pair of opposing longitudinal edges 37. The side panels 34 may be attached or bonded to the chassis 32 using any suitable bonding technique. For instance, the side panels 34 may be joined to the chassis by adhesives, ultrasonic bonds, thermal bonds, or other conventional techniques.

In an alternative embodiment, the elastic side panels may also be integrally formed with the chassis 32. For instance, the side panels 34 may comprise an extension of the bodyside liner 42, of the outer cover 40, or of both the bodyside liner 42 and the outer cover 40.

In the embodiments shown in the figures, the side panels 34 are connected to the back region of the absorbent article 20 and extend over the front region of the article when securing the article in place on a user. It should be understood, however, that the side panels 34 may alternatively be connected to the front region of the article 20 and extend over the back region when the article is donned.

With the absorbent article 20 in the fastened position as partially illustrated in FIGS. 1 and 2, the elastic side panels 34 may be connected by a fastening system 80 to define a 3-dimensional diaper configuration having a waist opening 50 and a pair of leg openings 52. The waist opening 50 of the article 20 is defined by the waist edges 38 and 39 which encircle the waist of the wearer.

In the embodiments shown in the figures, the side panels are releasably attachable to the front region 22 of the article 20 by the fastening system. It should be understood, however, that in other embodiments the side panels may be permanently joined to the chassis 32 at each end. The side panels may be permanently bonded together, for instance, when forming a training pant or absorbent swimwear.

The elastic side panels 34 each have a longitudinal outer edge 68, a leg end edge 70 disposed toward the longitudinal center of the diaper 20, and waist end edges 72 disposed toward a longitudinal end of the absorbent article. The leg end edges 70 of the absorbent article 20 may be suitably curved and/or angled relative to the lateral direction 49 to provide a better fit around the wearer's legs. However, it is understood that only one of the leg end edges 70 may be curved or angled, such as the leg end edge of the back region 24, or alternatively, neither of the leg end edges may be curved or angled, without departing from the scope of the present invention. As shown in FIG. 4, the outer edges 68 are generally parallel to the longitudinal direction 48 while the waist end edges 72 are generally parallel to the transverse axis 49. It should be understood, however, that in other embodiments the outer edges 68 and/or the waist edges 72 may be slanted or curved as desired. Ultimately, the side panels 34 are generally aligned with a waist region 90 of the chassis.

The fastening system 80 may include laterally opposite first fastening components 82 adapted for refastenable engagement to corresponding second fastening components 84. In the embodiment shown in the figures, the first fastening component 82 is located on the elastic side panels 34, while the second fastening component 84 is located on the front region 22 of the chassis 32. In one aspect, a front or outer surface of each of the fastening components 82, 84 includes a plurality of engaging elements. The engaging elements of the first fastening components 82 are adapted to repeatedly engage and disengage corresponding engaging elements of the second fastening components 84 to releasably secure the article 20 in its three-dimensional configuration.

The fastening components 82, 84 may be any refastenable fasteners suitable for absorbent articles, such as adhesive fasteners, cohesive fasteners, mechanical fasteners, or the like. In particular aspects the fastening components include mechanical fastening elements for improved performance. Suitable mechanical fastening elements can be provided by interlocking geometric shaped materials, such as hooks, loops, bulbs, mushrooms, arrowheads, balls on stems, male and female mating components, buckles, snaps, or the like.

In the illustrated aspect, the first fastening components 82 include hook fasteners and the second fastening components 84 include complementary loop fasteners. Alternatively, the first fastening components 82 may include loop fasteners and the second fastening components 84 may be complementary hook fasteners. In another aspect, the fastening components 82, 84 can be interlocking similar surface fasteners, or adhesive and cohesive fastening elements such as an adhesive fastener and an adhesive-receptive landing zone or material; or the like. One skilled in the art will recognize that the shape, density and polymer composition of the hooks and loops may be selected to obtain the desired level of engagement between the fastening components 82, 84. Suitable fastening systems are also disclosed in the previously incorporated PCT Patent Application WO 00/37009 published Jun. 29, 2000 by A. Fletcher et al. and the previously incorporated U.S. Pat. No. 6,645,190 issued Nov. 11, 2003 to Olson et al.

In the embodiment shown in the figures, the fastening components 82 are attached to the side panels 34 along the edges 68. In this embodiment, the fastening components 82 are not elastic or extendable. In other embodiments, however, the fastening components may be integral with the side panels 34. For example, the fastening components may be directly attached to the side panels 34 on a surface thereof.

In addition to possibly having elastic side panels, the absorbent article 20 may include various waist elastic members for providing elasticity around the waist opening. For example, as shown in the figures, the absorbent article 20 can include a front waist elastic member 54 and/or a back waist elastic member 56.

As described above, the present disclosure is particularly directed to incorporating a body fluid indicating system, such as a wetness sensing device into the absorbent article 20. In this regard, as shown in FIGS. 1-4, the absorbent article 20 includes a first conductive element 100 spaced from a second conductive element 102. In this embodiment, the conductive elements extend from the front region 22 of the absorbent article to the back region 24 without intersecting. The conductive elements 100 and 102 can comprise any suitable conductive material, such as a conductive thread or a conductive foil. The first conductive element 100 does not intersect the second conductive element 102 in order to form an open circuit that may be closed, for instance, when a conductive fluid is positioned in between the conductive elements. In other embodiments, however, the first conductive element 100 and the second conductive element 102 may be connected to a sensor within the chassis. The sensor may be used to sense changes in temperature or may be used to sense the presence of a particular substance, such as a metabolite.

In the embodiment shown in FIG. 1, the conductive elements 100 and 102 extend the entire length of the absorbent article 20. It should be understood, however, that in other embodiments the conductive elements may extend only to the crotch region 26 or may extend to any particular place in the absorbent article where a body fluid is intended to be sensed.

The conductive elements 100 and 102 may be incorporated into the chassis 32 at any suitable location as long as the conductive elements are positioned so as to contact a body fluid that is absorbed by the absorbent article 20. In this regard, the conductive elements 100 and 102 generally lie inside the outer cover 40. In fact, in one embodiment, the conductive elements 100 and 102 may be attached or laminated to the inside surface of the outer cover 40 that faces the absorbent structure 44. Alternatively, however, the conductive elements 100 and 102 may be positioned on the absorbent structure 44 or positioned on the liner 42.

In order for the conductive elements 100 and 102 to be easily connected to a signaling device, the first conductive element 100 is attached to a first conductive pad member 104, while the second conductive element 102 is connected to a second conductive pad member 106. The pad members 104 and 106 are provided for making a reliable connection between the open circuit formed by the conductive elements to a signaling device that is intended to be installed on the chassis by the consumer.

The position of the conductive pad members 104 and 106 on the absorbent article 20 can vary depending upon where it is desired to mount the signaling device. For instance, in FIGS. 1, 3 and 4, the conductive pad members 104 and 106 are positioned in the front region 22 along the waist opening of the article. In FIG. 2, on the other hand, the conductive pad members 104 and 106 are positioned in the back region 24 along the waist opening of the article. It should be appreciated, however, that in other embodiments, the absorbent article 20 may include conductive pad members being positioned at each end of each conductive element 100 and 102. In this manner, a user can determine whether or not to install the signaling device on the front or the back of the article. In still other embodiments, it should be understood that the pad members may be located along the side of the article or towards the crotch region of the article.

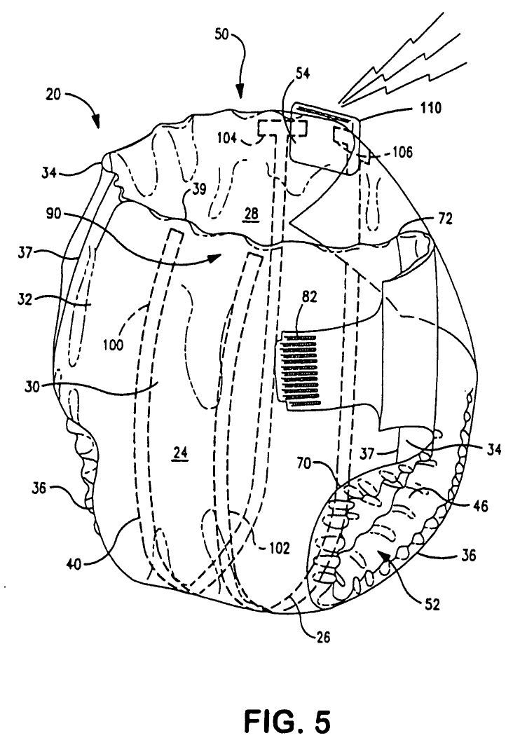

Referring to FIG. 5, for exemplary purposes, a signaling device 110 is shown attached to the conductive pad members 104 and 106. The signaling device 110 includes a pair of opposing terminals that are electrically connected to the corresponding conductive pad members. When a body fluid is present in the absorbent article 20, the open circuit formed by the conductive elements 100 and 102 is closed which, in turn, activates the signaling device 110.

The signaling device 110 can emit an audible signal in order to indicate to the user that the circuit has been closed. The audible signal, for instance, may be as simple as one or more beeps to perhaps emitting a musical tune.

In accordance with the present disclosure, the audible signal emitted by the signaling device has an adjusted frequency or range of frequencies that maximize the perceived loudness of the signal within a particular environment without having to increase the intensity of the signal or the audio power to a point where battery life is sacrifice. The particular type of sound emitted by the signaling device and/or the frequency or range of frequencies of the sound can vary in accordance with the present disclosure depending upon a particular application and environment in which the signaling device is to be used. For example, the frequency or range of frequencies emitted by the signaling device can vary depending upon whether or not the signaling device is worn under clothing or remains uncovered during wear.

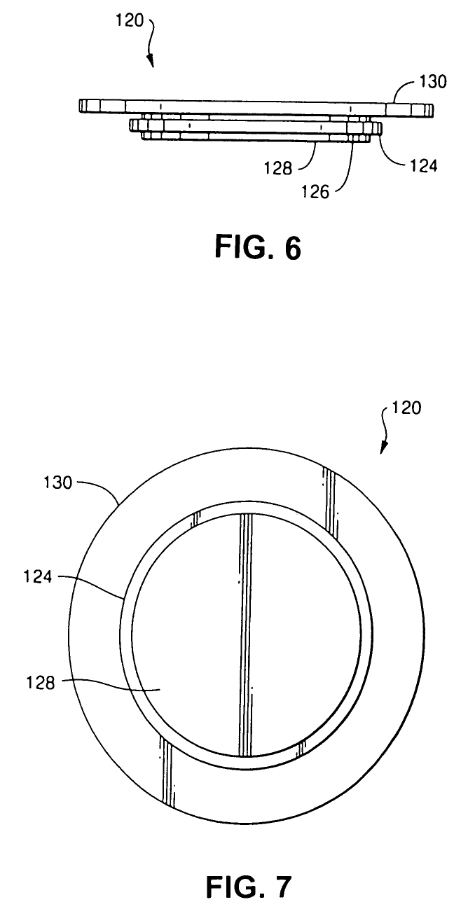

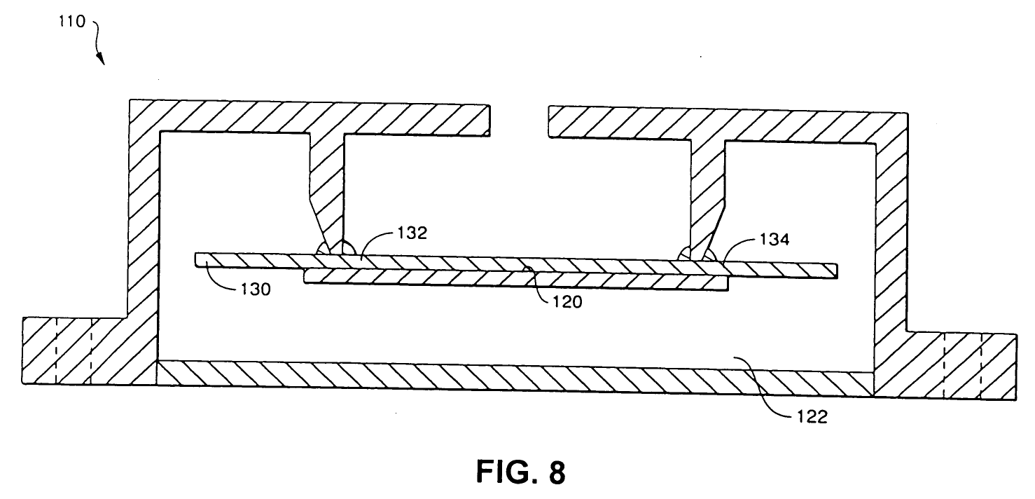

In general, the signaling device can comprise any suitable sound emitting device. In one embodiment, for instance, the signaling device may comprise a sound device including cone and magnet speakers. Alternatively, the signaling device may comprise a piezoelectric device. For example one embodiment of a piezoelectric sound device 110 is shown in FIG. 8. A illustrated, the piezoelectric sound device 110 includes a diaphragm 120 contained within an acoustic chamber 122. The diaphragm 120 is more particularly illustrated in FIGS. 6-7. The diaphragm 120 includes a ceramic plate 124 positioned in between a first electrode 126 and a second electrode 128. The electrodes and the ceramic plate rest on a metal plate 130. When a voltage is applied across the electrodes, the diaphragm vibrates producing sound waves.

As shown in FIG. 8, the diaphragm 120 is mounted in the acoustic chamber 122 in order to produce high sound pressure. Suitable piezoelectric devices that may be used in the present disclosure are commercially available from numerous sources including Muratta Manufacturing Company and from CUI Inc.

In designing a signaling device in accordance with the present disclosure, once a frequency or range of frequencies is selected, the signaling device, such as the piezoelectric device 110 as shown in FIGS. 6-8 can be configured to emit an audible signal at the selected frequency or frequency range. For example, the frequency of the sound emitted by the piezoelectric device 110 can be adjusted in numerous ways.

More particularly, the piezoelectric device 110 can be designed so as to have a particular resonant frequency. Resonance is the tendency of the device to oscillate at maximum amplitude at a certain frequency. This frequency is known as the system's resonant frequency. In order to maximize loudness at a particular power, in one embodiment, the piezoelectric device can be configured to have a resonant frequency at the frequency which perceived loudness in an environment is also maximized. The resonant frequency of the piezoelectric device 110 can be varied using numerous methods. For instance, in one embodiment, the resonant frequency can be adjusted by changing the materials used to form the diaphragm 120. For instance, increasing or decreasing the thickness of the ceramic plate 124 has an influence on the resonant frequency. The thickness of the metal plate 130 and the type of metal used to form the plate also can have an influence on the resonant frequency.

In addition, the resonant frequency of the piezoelectric device can also be influenced by the manner in which the diaphragm is supported in the acoustic chamber 122. In the embodiment illustrated in FIG. 8, for instance, the diaphragm 120 is supported at the nodes 132 and 134. The resonant frequency in the chamber, however, can be changed by supporting the diaphragm 120 in the center (a single support) or can be changed by supporting the diaphragm at the edges of the metal plate 130.

The dimensions of the acoustic chamber 122 can also influence the sound emitted by the piezoelectric device 110. The acoustic chamber 122, for instance, allows for a particular frequency to resonate most efficiently. More particularly, the combination of the tuned resonance of the diaphragm 120 and the resonance of the acoustic chamber 122 can provide a variety of loudness levels. If the resonant frequency of the diaphragm is matched to the frequency of the acoustic chamber, the maximum loudness level can be achieved. The divergence of these two parameters can adjust the loudness levels to a particular application.

In accordance with the present disclosure, the parameters as described above and in particular the frequency can be adjusted in order to optimize the perceived loudness of the signaling device. In one embodiment, for instance, the signaling device emits the audible signal at an intensity of less than about 80 dB, such as less than about 70 dB, such as less than about 65 dB. Intensity levels greater than above may compromise battery life.

At the above initial intensity of the audible signal, in one embodiment, the frequency or range of frequencies of the signal can be adjusted so that the intensity of the signal is at least at about 48 dB, such as at least about 52 dB, such as at least about 56 dB at a distance of 20 feet from the signaling device.

At the above initial intensities, the frequency or range of frequencies of the audible signal can also be adjusted and selected such that the intensity of the signal does not decrease by a certain amount when the signaling device is covered by a material. For instance, in one embodiment, the frequency or range of frequencies of the audible signal can be selected so that the intensity of the signal does not decrease by more than about 15 percent, such as more than 10 percent, when the signaling device is covered by a standard cotton cloth, a standard polyester/cotton woven fabric and/or a standard denim fabric. The standard fabrics are intended to assimilate conditions where the signaling device is covered by a shirt, a gown, or by pants.

The audible signal itself can vary depending upon the particular application. For instance, in one embodiment, the audible signal may comprise a solid tone or repeating tones. In one embodiment, the audible signal may comprise a sequence of variable tones, such as a voice or musical recording.

These and other modifications and variations to the present invention may be practiced by those of ordinary skill in the art, without departing from the spirit and scope of the present invention, which is more particularly set forth in the appended claims. In addition, it should be understood that aspects of the various embodiments may be interchanged both in whole or in part. Furthermore, those of ordinary skill in the art will appreciate that the foregoing description is by way of example only, and is not intended to limit the invention so further described in such appended claims.

What is claimed:

1. An absorbent article comprising:
a chassis comprising an outer cover having an interior surface and an exterior surface and an absorbent structure positioned adjacent the interior surface of the outer cover, the chassis including a crotch region positioned in between a front region and a back region, the front region and the back region defining a waist region therebetween; and
a wetness sensing device that is activated when a conductive substance is detected in the absorbent article, the wetness sensing device including a signaling device that produces an audible signal when the wetness 10 sensing device is activated, the signaling device being configured to initially emit an audible signal that has an intensity of less than about 80 dB and at selected frequency or range of frequencies such that the intensity of the audible signal is greater than about 48 dB at a distance of 20 feet from the signaling device.

2. An absorbent article as defined in claim 1, wherein the frequency or range of frequencies of the audible signal are also selected such that the intensity decreases by no more than about 15 percent when the signaling device is covered by a standard cotton cloth.

3. An absorbent article as defined in claim 1, wherein the signaling device comprises a piezoelectric device.

4. An absorbent article as defined in claim 1, wherein the signaling device contains a battery that has a useful life of at least 72 hours if the signaling device constantly produces the audible signal.

5. An absorbent article as defined in claim 1, wherein the audible signal that is emitted by the signaling device has an initial intensity of less than about 70 dB.

6. An absorbent article as defined in claim 1, wherein the selected frequency or range of frequencies is from about 500 Hz to about 2000 Hz.

7. An absorbent article as defined in claim 1, wherein the audible signal comprises a solid tone.

8. An absorbent article as defined in claim 1, wherein the audible signal comprises a repeating tone.

9. An absorbent article as defined in claim 1, wherein the audible signal comprises a sequence of variable tones.

10. An absorbent article as defined in claim 1, wherein the audible signal comprises a voice or musical recording.

11. An absorbent article as defined in claim 1, wherein the signaling device includes an acoustic chamber, the signaling device having a resonant frequency that matches a frequency of the acoustic chamber.

12. An absorbent article as defined in claim 1, wherein the absorbent article comprises a diaper or a training pant.

13. An absorbent article as defined in claim 1, wherein the signaling device comprises a sound device containing a cone and magnet speaker.

14. An absorbent article as defined in claim 1, wherein the frequency or range of frequencies of the audible signal are also selected such that the intensity decreases by no more than about 15% when the signaling device is covered by a standard polyester/cotton woven fabric.

15. An absorbent article as defined in claim 1, wherein the frequency or range of frequencies of the audible signal are also selected such that the intensity decreases by no more than about 15% when the signaling device is covered by a standard denim fabric.

16. An absorbent article comprising:
a chassis comprising an outer cover having an interior surface and an exterior surface and an absorbent structure positioned adjacent the interior surface of the outer cover, the chassis including a crotch region positioned in between a front region and a back region, the front region and the back region defining a waist region therebetween; and
a wetness sensing device that is activated when a conductive substance is detected in the absorbent article, the wetness sensing device including a signaling device that produces an audible signal when the wetness sensing device is activated, the signaling device being configured to initially emit an audible signal that has an intensity of less than about 80 dB and at selected frequency or range of frequencies such that the intensity decreases by no more than about 15 percent when covered by a standard cotton cloth.

17. An absorbent article as defined in claim 16, wherein the frequency or range of frequencies is selected such that the intensity decreases by no more than about 10 percent when covered by the standard cotton cloth.

18. An absorbent article as defined in claim 16, wherein the signaling device comprises a piezoelectric device.

19. An absorbent article as defined in claim 16, wherein the frequency or the range of frequencies is further selected such that the intensity of the audible signal is at least about 48 dB at a distance of 20 feet from the signaling device.

20. An absorbent article as defined in claim 16, wherein the audible signal that is emitted by the signaling device has an initial intensity of less than about 70 dB.

21. An absorbent article as defined in claim 16, wherein the selected frequency or range of frequencies is from about 500 Hz to about 2000 Hz.

22. An absorbent article as defined in claim 16, wherein the audible signal comprises a solid tone.

23. An absorbent article as defined in claim 16, wherein the audible signal comprises a sequence of variable tones.

24. An absorbent article as defined in claim 16, wherein the absorbent article comprises a diaper or a training pant.

25. An absorbent article as defined in claim 16, wherein the signaling device comprises a sound device containing a cone and magnet speaker.

26. A method for increasing the perceived loudness of an audible signal of a signaling device on an absorbent article, the signaling device being in communication with a wetness sensing device that is activated when a conductive substance is detected in the absorbent article, wherein, when the wetness sensing device is activated, the signaling device produces the audible signal at an intensity of less than about 80 dB, the method comprises adjusting a frequency of the audible signal in a manner such that the audible signal has an intensity of at least about 48 dB at a distance of 20 feet from the signaling device.

27. A method as defined in claim 26, wherein the frequency of the audible signal is also adjusted such that the intensity decreases by no more than about 15 percent when the signaling device is covered by a standard cotton cloth.
